(19) United States
(12) Patent Application Publication
(10) Pub. No.: US 2014/0321906 A1
(43) Pub. Date: Oct. 30, 2014

(54) Light-Permeable Fixing Component

(71) Applicant: Ting-Jui WANG, New Taipei City (TW)

(72) Inventor: Ting-Jui WANG, New Taipei City (TW)

(21) Appl. No.: 13/940,131

(22) Filed: Jul. 11, 2013

(30) Foreign Application Priority Data
Apr. 30, 2013 (TW) 102115487

(51) Int. Cl. F16B 21/06; F16B 17/00

(52) U.S. Cl. CPC F16B 21/06; F16B 17/00
USPC 403/299

(57) ABSTRACT

A light-permeable fixing component includes a fixed head portion, a fixed body, a receiving channel, a light-permeable body and a sleeve. The fixed body is connected to the fixed head portion. The fixed body has a fixing portion. The fixing portion is disposed at the fixed body. The fixing portion is a thread, hook engagement bodies or snap-engagement bodies. The receiving channel penetrates the fixed head portion and the fixed body. The light-permeable body is disposed inside the receiving channel. The sleeve is movably connected to the fixed body. Hence, the light-permeable fixing component is illuminated with a light source to thereby be capable of guiding light, emitting light, glittering, decoration and indicating a constant depth.

### CROSS-REFERENCE TO RELATED APPLICATION

This non-provisional application claims priority under 35 U.S.C. §119(a) on Patent Application No(s). 102115487 filed in Taiwan, R.O.C. on Apr. 30, 2013, the entire contents of which are hereby incorporated by reference.

### FIELD OF THE INVENTION

The present invention relates to light-permeable fixing components, and more particularly, to a light-permeable fixing component capable of guiding light, emitting light, glittering, decoration and indicating a constant depth when illuminated.

### BACKGROUND OF THE INVENTION

The purpose of a conventional fixing component is to fix an object to another object. However, at a dark place, the conventional fixing component cannot be perceived readily and thus cannot be repaired properly. Furthermore, the conventional fixing component itself is fixed to an object monotonously, and in consequence the resultant finished product is monotonous in appearance. Also, if the conventional fixing component has to be fixed to a constant depth, the conventional fixing component will have to be measured with a tool of measurement, thereby rendering it inconvenient to fix the object in place with.

Accordingly, it is imperative to provide a light-permeable fixing component capable of guiding light, emitting light, glittering, decoration and indicating a constant depth when illuminated.

### SUMMARY OF THE INVENTION

In view of the aforesaid drawbacks of the prior art, the inventor of the present invention conceived room for improvement in the prior art and thus conducted extensive researches and experiments according to the inventor's years of experience in the related industry, and finally developed a light-permeable fixing component capable of guiding light, emitting light, glittering, decoration and indicating a constant depth when illuminated.

In order to achieve the above and other objectives, the present invention provides, in the first embodiment, a light-permeable fixing component comprising: a fixed body having a fixing portion, the fixing portion being disposed at the fixed body and being one of a thread, hook engagement bodies and snap-engagement bodies; a receiving channel penetrating the fixed body; and a light-permeable body disposed inside the receiving channel.

The present invention provides, in the second embodiment, a light-permeable fixing component comprising: a fixed head portion; a fixed body connected to the fixed head portion and having a fixing portion, the fixing portion being disposed at the fixed body and being one of a thread, hook engagement bodies and snap-engagement bodies; a receiving channel penetrating the fixed head portion and the fixed body; and a light-permeable body disposed inside the receiving channel.

The present invention provides, in the third embodiment, a light-permeable fixing component comprising: a fixed head portion; a fixed body connected to the fixed head portion and having a fixing portion, the fixing portion being disposed at the fixed body and being one of a thread, hook engagement bodies and snap-engagement bodies; a receiving channel penetrating the fixed head portion and the fixed body; a light-permeable body disposed inside the receiving channel; and a sleeve movably connected to the fixed body.

As regards the light-permeable fixing component in the first embodiment, the light-permeable body protrudes from the fixed body.

As regards the light-permeable fixing component in the second embodiment or the third embodiment, the light-permeable body protrudes from the fixed head portion and/or the fixed body.

As regards the light-permeable fixing component in the first embodiment, the second embodiment, and the third embodiment, the light-permeable body is disposed inside the receiving channel by adhesion, insert injection, press-in, engagement, snap-engagement or thermal fusion.

As regards the light-permeable fixing component in the first embodiment, the second embodiment, and the third embodiment, the receiving channel has at least a first coupling portion, or the light-permeable body has at least a second coupling portion, wherein the first coupling portion and the second coupling portion are a protrusion or a recess.

As regards the light-permeable fixing component in the first embodiment, the second embodiment, and the third embodiment, the light-permeable body has an external thread, and the receiving channel has an internal thread, such that the external thread and the internal thread mesh with each other.

The light-permeable fixing component in the first embodiment further comprises a cap, and the fixed body is connected to the cap, whereas the receiving channel penetrates the cap.

The light-permeable fixing component in the second embodiment further comprises a cap, and the fixed head portion is connected to the cap, whereas the receiving channel penetrates the cap.

The light-permeable fixing component in the third embodiment further comprises a cap connected to the fixed head portion and penetrated by the receiving channel, wherein the sleeve is movably connected to the fixed body or the cap.

The light-permeable fixing component in the first embodiment further comprises a sleeve movably connected to the fixed body or the cap.

The light-permeable fixing component in the third embodiment further comprises a resilient component with one end abutting against the fixed head portion and the other end abutting against the sleeve.

The light-permeable fixing component in the third embodiment further comprises a resilient component with one end abutting against the fixed head portion or the cap and the other end abutting against the sleeve.

The light-permeable fixing component in the first embodiment further comprises a resilient component with one end abutting against the cap and the other end abutting against the sleeve.

As regards the light-permeable fixing component in the first embodiment, the second embodiment or the third embodiment, the fixed body is made of a metal.

As regards the light-permeable fixing component in the first embodiment, the second embodiment or the third embodiment, the light-permeable body is made from optical fiber, fibrous material, plastic, glass, quartz, acrylic, rubber, and silicone.

As regards the light-permeable fixing component in the first embodiment, the fixed body has a first operation portion.

As regards the light-permeable fixing component in the second embodiment or the third embodiment, the fixed head portion has a second operation portion.

Accordingly, the light-permeable fixing component of the present invention is capable of guiding light, emitting light, glittering, decoration and indicating a constant depth when illuminated.

### BRIEF DESCRIPTION OF THE DRAWINGS

Objectives, features, and advantages of the present invention are hereunder illustrated with specific embodiments in conjunction with the accompanying drawings, in which:

FIG. 1a through FIG. 1c are schematic views of a fixed body of a light-permeable fixing component according to the first specific embodiment of the present invention;

FIG. 2a through FIG. 2c are schematic views of a fixed head portion of the light-permeable fixing component according to the second specific embodiment of the present invention;

FIG. 3a through FIG. 3c are schematic views of the light-permeable fixing component according to the third specific embodiment of the present invention;

FIG. 4a through FIG. 4c are schematic views of a light-permeable body of the light-permeable fixing component according to the first specific embodiment of the present invention;

FIG. 5a through FIG. 5c are schematic views of the light-permeable body of the light-permeable fixing component according to the second specific embodiment of the present invention;

FIG. 6a through FIG. 6c are schematic views of the light-permeable body of the light-permeable fixing component according to the third specific embodiment of the present invention;

FIG. 7a through FIG. 7c are schematic views of the light-permeable body coupled to a receiving channel according to the first specific embodiment of the present invention;

FIG. 8a through FIG. 8c are schematic views of the light-permeable body coupled to the receiving channel according to the second specific embodiment of the present invention;

FIG. 9a through FIG. 9c are schematic views of the light-permeable body coupled to the receiving channel according to the third specific embodiment of the present invention;

FIG. 10a through FIG. 10c are schematic views of the light-permeable body fastened to the receiving channel according to the first specific embodiment of the present invention;

FIG. 11a through FIG. 11c are schematic views of the light-permeable body fastened to the receiving channel according to the second specific embodiment of the present invention;

FIG. 12a through FIG. 12c are schematic views of the light-permeable body fastened to the receiving channel according to the third specific embodiment of the present invention;

FIG. 13a through FIG. 13c are schematic views of the fixed body to which a cap is connected according to the first specific embodiment of the present invention;

FIG. 14a through FIG. 14c are schematic views of the light-permeable fixing component with the cap according to the second specific embodiment of the present invention;

FIG. 15a through FIG. 15c are schematic views of the light-permeable fixing component with the cap according to the third specific embodiment of the present invention;

FIG. 16a through FIG. 16c are schematic views of the light-permeable fixing component with the cap and a sleeve according to the first specific embodiment of the present invention;

FIG. 17a through FIG. 17c are schematic views of the light-permeable fixing component with a resilient component according to the third specific embodiment of the present invention;

FIG. 18a through FIG. 18c are schematic views of the light-permeable fixing component with the cap and the resilient component according to the third specific embodiment of the present invention;

FIG. 19a through FIG. 19c are schematic views of the light-permeable fixing component with the cap, the sleeve, and the resilient component according to the first specific embodiment of the present invention;

FIG. 20 is a schematic view of the use of the light-permeable fixing component in a specific embodiment of the present invention;

FIG. 21a through FIG. 21c are schematic views of an operation portion according to a specific embodiment of the present invention; and

FIG. 22 is a schematic view of the operation portion according to a specific embodiment of the present invention.

### DETAILED DESCRIPTION OF THE PREFERRED EMBODIMENTS

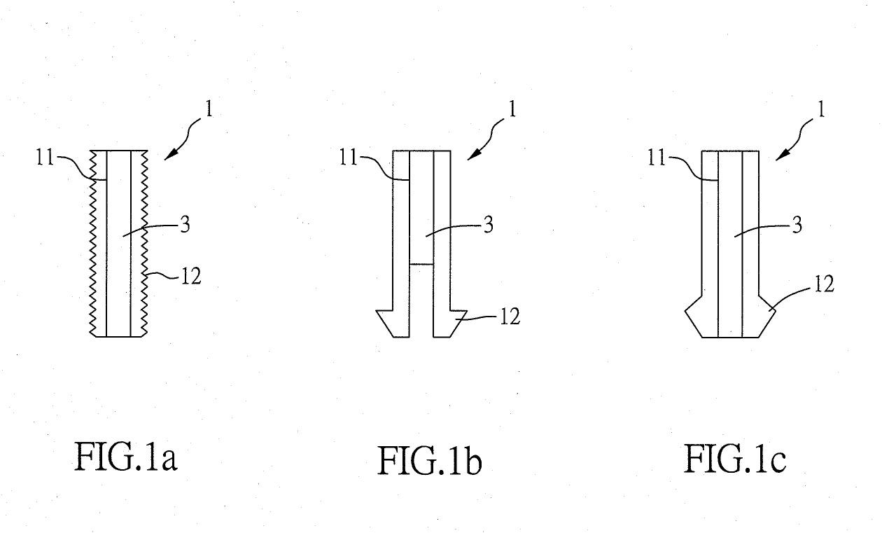

FIG. 1a through FIG. 1c are schematic views of a fixed body of a light-permeable fixing component according to the first specific embodiment of the present invention. As shown in the diagrams, in the first specific embodiment of the present invention, the light-permeable fixing component comprises a fixed body 1, a receiving channel 11 and a light-permeable body 3. The fixed body 1 comprises a fixing portion 12. The fixing portion 12 is disposed at the fixed body 1. The fixing portion 12 is a thread (FIG. 1a), two hook engagement bodies (FIG. 1b) or two snap-engagement bodies (FIG. 1c). The fixed body 1 can be a screw. Both the hook engagement bodies and the snap-engagement bodies are resilient. Two hook engagement bodies (FIG. 1b) have a notch therebetween, and so do the two snap-engagement bodies (FIG. 1c). The two snap-engagement bodies (FIG. 1c) lack a notch therebetween, and neither do the two hook engagement bodies (FIG. 1b). The receiving channel 11 penetrates the fixed body 1. The light-permeable body 3 is disposed in the receiving channel 11. The fixed body 1 is columnar and has a round cross-section or a square cross-section, for example. The fixing portion 12 is disposed at the fixed body 1 in whole or in part, for example, at the top, the middle, or the bottom of the fixed body 1, or a combination thereof. The light-permeable body 3 is disposed inside the receiving channel 11 in whole or in part, for example, at the top, the middle, or the bottom of the receiving channel 11, or a combination thereof. To start using the light-permeable fixing component of the present invention, a user grabs its top end and manipulates the light-permeable fixing component of the present invention.

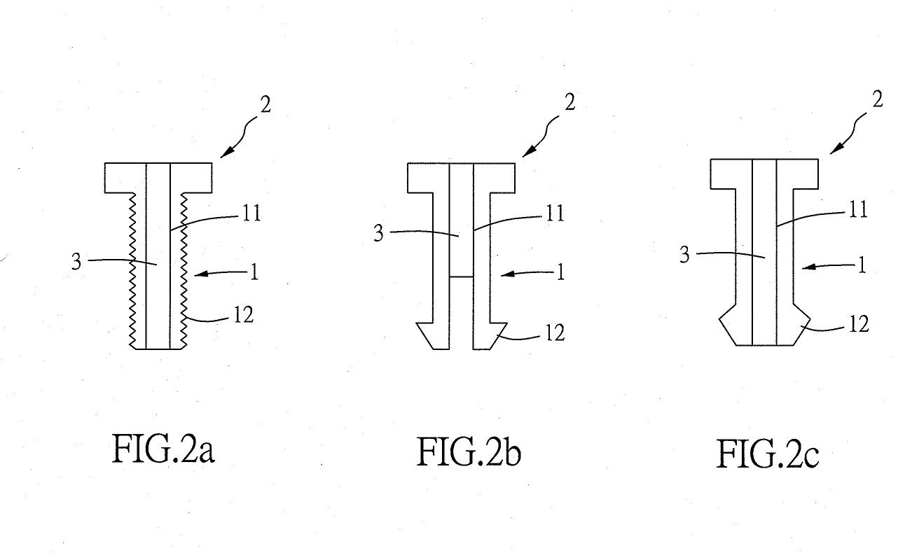

FIG. 2a through FIG. 2c are schematic views a fixed head portion of the light-permeable fixing component according to the second specific embodiment of the present invention. As shown in the diagrams, the light-permeable fixing component according to the second specific embodiment of the present invention comprises a fixed head portion 2, a fixed body 1, a receiving channel 11 and a light-permeable body 3. The fixed body 1 is connected to the fixed head portion 2 integrally to form a unitary structure. The fixed body 1 comprises a fixing portion 12. The fixing portion 12 is disposed at the fixed body 1. The fixing portion 12 is a thread (FIG. 2a), hook engagement bodies (FIG. 2b) or snap-engagement bodies (FIG. 2c). The fixed body 1 and the fixed head portion 2 can form a screw. The receiving channel 11 penetrates the fixed head portion 2 and the fixed body 1. The light-permeable body 3 is disposed inside the receiving channel 11. The fixed head portion 2 is of a cross-section larger than the fixed body 1, such that the user can manipulate the light-permeable fixing component of the present invention easily. The fixed body 1 is columnar and has a round cross-section or a square cross-section, for example. The fixing portion 12 is disposed at the fixed body 1 in whole or in part, for example, at the top, the middle, or the bottom of the fixed body 1, or a combination thereof. The light-permeable body 3 is disposed inside the receiving channel 11 in whole or in part, for example, at the top, the middle, or the bottom of the receiving channel 11, or a combination thereof. To start using the light-permeable fixing component of the present invention, the user grabs the fixed head portion 2 and manipulates the light-permeable fixing component of the present invention.

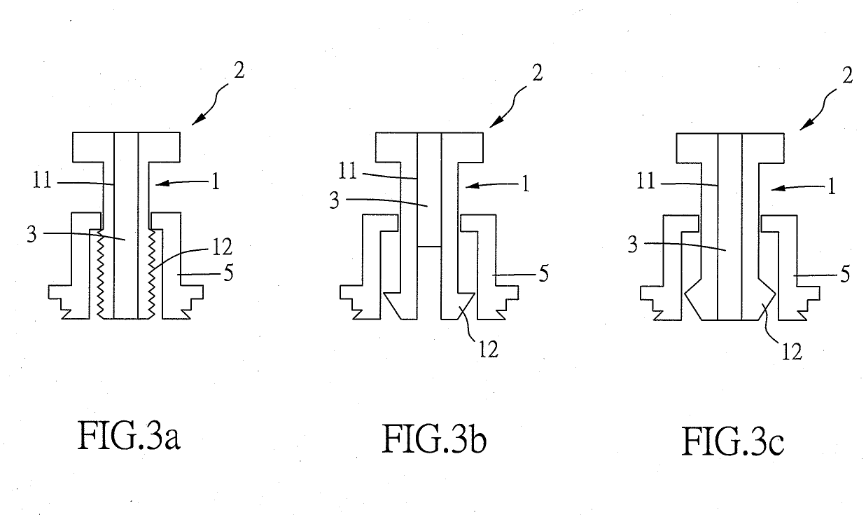

FIG. 3a through FIG. 3c are schematic views of the light-permeable fixing component according to the third specific embodiment of the present invention. As shown in the diagrams, the light-permeable fixing component according to the third specific embodiment of the present invention comprises a fixed head portion 2, a fixed body 1, a receiving channel 11, a light-permeable body 3 and a sleeve 5. The fixed body 1 is connected to the fixed head portion 2 integrally to form a unitary structure. The fixed body 1 comprises a fixing portion 12. The fixing portion 12 is disposed at the fixed body 1. The fixing portion 12 is a thread (FIG. 3a), hook engagement bodies (FIG. 3b) or snap-engagement bodies (FIG. 3c). The fixed body 1 and the fixed head portion 2 can form a screw. The receiving channel 11 penetrates the fixed head portion 2 and the fixed body 1. The light-permeable body 3 is disposed inside the receiving channel 11. The sleeve 5 is movably connected to the fixed body 1. The fixed head portion 2 is of a larger cross-section than the fixed body 1, such that the user can manipulate the light-permeable fixing component of the present invention easily. The fixed body 1 is columnar and has a round cross-section or a square cross-section, for example. The fixing portion 12 is disposed at the fixed body 1 in whole or in part, for example, at the top, the middle, or the bottom of the fixed body 1, or a combination thereof. The light-permeable body 3 is disposed inside the receiving channel 11 in whole or in part, for example, at the top, the middle, or the bottom of the receiving channel 11, or a combination thereof. The sleeve 5 has an upper rim which protrudes inward and abuts movably against the fixing portion 12. Alternatively, the sleeve 5 has a stop ring (not shown) which abuts movably against the fixing portion 12, and then the upper rim of the sleeve 5 protrudes inward and abuts movably against the fixing portion 12. To start using the light-permeable fixing component of the present invention, the user grabs the fixed head portion 2 and manipulates the light-permeable fixing component of the present invention.

As mentioned earlier, the light-permeable fixing component of the present invention is characterized in that the light-permeable body 3 guides light generated from a light source (not shown) in traveling from the lower end of the light-permeable fixing component to the upper end thereof for the sake of emitting light. Furthermore, the light-permeable fixing component of the present invention glitters together with the light source synchronously. Hence, the light-permeable fixing component of the present invention is capable of guiding light, emitting light, glittering and decoration. Also, as soon as the light-permeable fixing component of the present invention is fixed to a constant depth, its lower end contacts and starts the light source such that the upper end of the light-permeable fixing component of the present invention emits light. Hence, the light-permeable fixing component of the present invention is capable of indicating a constant depth.

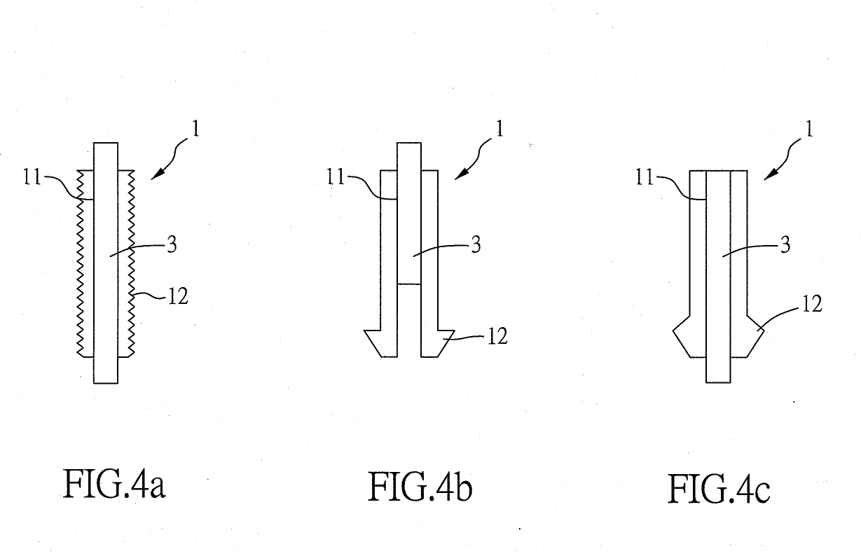

FIG. 4a through FIG. 4c are schematic views of the light-permeable body according to the first specific embodiment of the present invention. As shown in the diagrams, the light-permeable body 3 of the light-permeable fixing component in the first specific embodiment protrudes from the upper end of the fixed body 1 such that the light-permeable fixing component of the present invention can emit light easily. Furthermore, it is also feasible for the light-permeable body 3 to protrude from the lower end of the fixed body 1, so as for the light-permeable body 3 to have a larger surface area facing the light source (not shown) and thus absorb light better. Also, by protruding from the lower end of the fixed body 1, the light-permeable body 3 enables the light-permeable fixing component of the present invention to start the light source by means of the contact between the light-permeable body 3 and the light source.

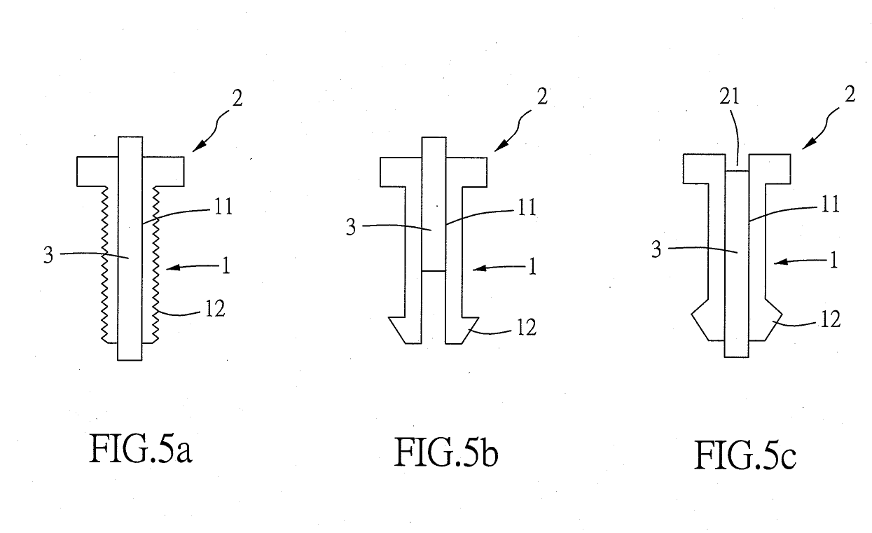

FIG. 5a through FIG. 5c are schematic views of the light-permeable body of the light-permeable fixing component according to the second specific embodiment of the present invention. As shown in the diagrams, in the second specific embodiment, the light-permeable body 3 of the light-permeable fixing component protrudes from the upper end of the fixed head portion 2, the lower end of the fixed body 1, or a combination thereof to thereby achieve the same degree of performance and advantages as in the first specific embodiment of the present invention.

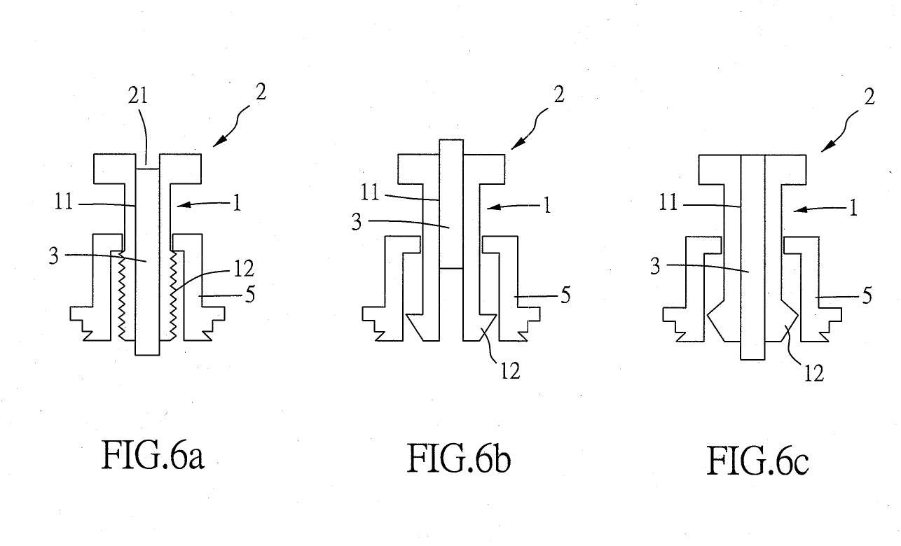

FIG. 6a through FIG. 6c are schematic views of the light-permeable body of the light-permeable fixing component according to the third specific embodiment of the present invention. As shown in the diagrams, in the third specific embodiment, the light-permeable body 3 of the light-permeable fixing component protrudes from the upper end of the fixed head portion 2, the lower end of the fixed body 1, or a combination thereof to thereby achieve the same degree of performance and advantages as in the first specific embodiment of the present invention.

The light-permeable body 3 of the light-permeable fixing component is disposed inside the receiving channel 11 by adhesion (including photocuring adhesion), insert injection, press-in, engagement, snap-engagement or thermal fusion.

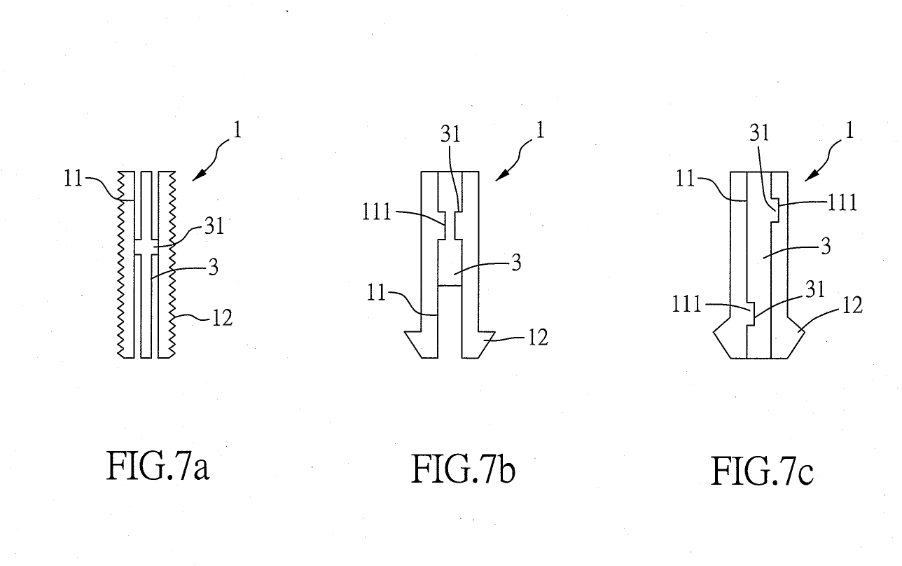

FIG. 7a through FIG. 7c are schematic views of the light-permeable body coupled to a receiving channel according to the first specific embodiment of the present invention. As shown in the diagrams, in the first specific embodiment, the receiving channel 11 of the light-permeable fixing component comprises at least a first coupling portion 111, or the light-permeable body 3 has at least a second coupling portion 31. The first coupling portion 111 and the second coupling portion 31 are a protrusion or a recess. As soon as the light-permeable body 3 is disposed inside the receiving channel 11 by insert injection or thermal fusion, the light-permeable body 3 forms a protrusion or recess corresponding in position to the recess or protrusion of the receiving channel 11, such that the light-permeable body 3 is firmly snap-engaged with the receiving channel 11. Furthermore, as soon as the light-permeable body 3 is disposed inside the receiving channel 11 by press-in, the protrusion of the light-permeable body 3 causes the light-permeable body 3 to be inserted into the receiving channel 11 tightly, such that the light-permeable body 3 is fixed to the receiving channel 11 from within. In addition, the first coupling portion 111 and the second coupling portion 31 can also be a knurl.

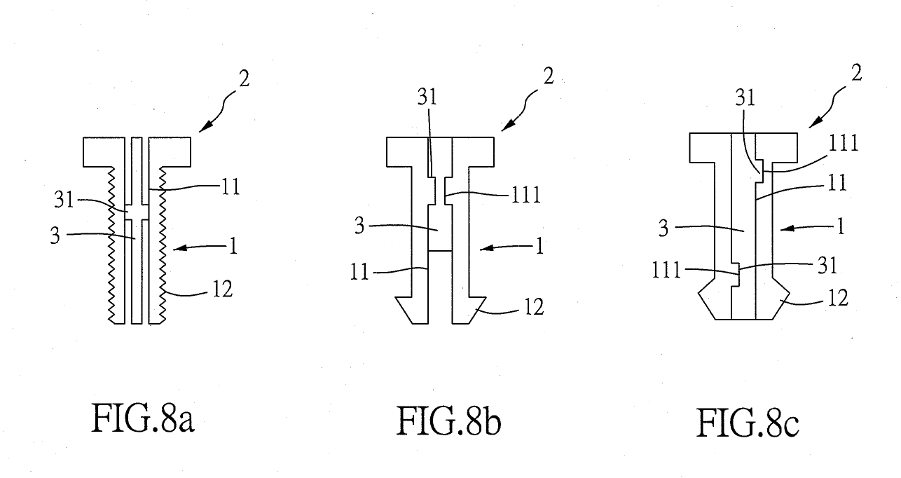

FIG. 8a through FIG. 8c are schematic views of the light-permeable body coupled to the receiving channel according to the second specific embodiment of the present invention. As shown in the diagrams, in the second specific embodiment, the receiving channel 11 of the light-permeable fixing component has at least a first coupling portion 111, or the light-permeable body 3 has at least a second coupling portion 31. The first coupling portion 111 and the second coupling portion 31 are the protrusion or the recess which have the same functions and advantages as their counterparts in the first specific embodiment of the present invention. In addition, the first coupling portion 111 and the second coupling portion 31 can also be a knurl.

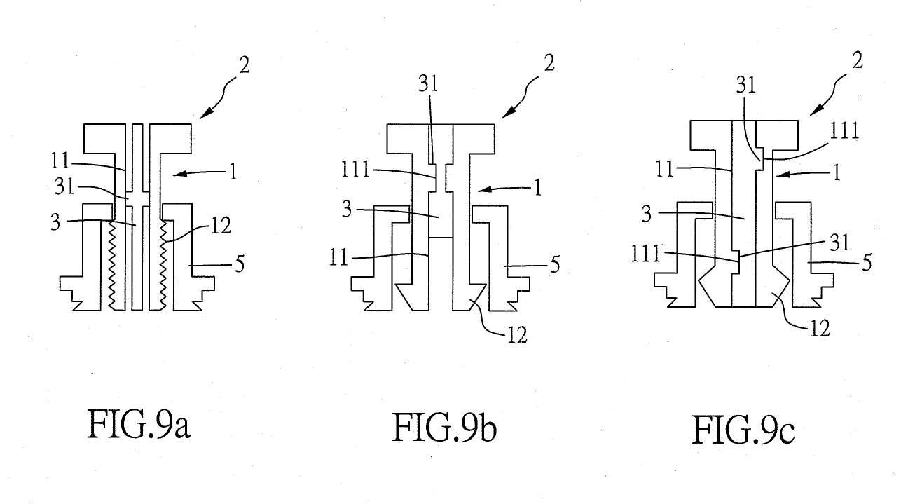

FIG. 9a through FIG. 9c are schematic views of the light-permeable body coupled to the receiving channel according to the third specific embodiment of the present invention. As shown in the diagrams, in the third specific embodiment, the receiving channel 11 of the light-permeable fixing component has at least a first coupling portion 111, or the light-permeable body 3 has at least a second coupling portion 31. The first coupling portion 111 and the second coupling portion 31 are the protrusion or the recess which have the same functions and advantages as the first specific embodiment of the present invention. In addition, the first coupling portion 111 and the second coupling portion 31 can also be a knurl.

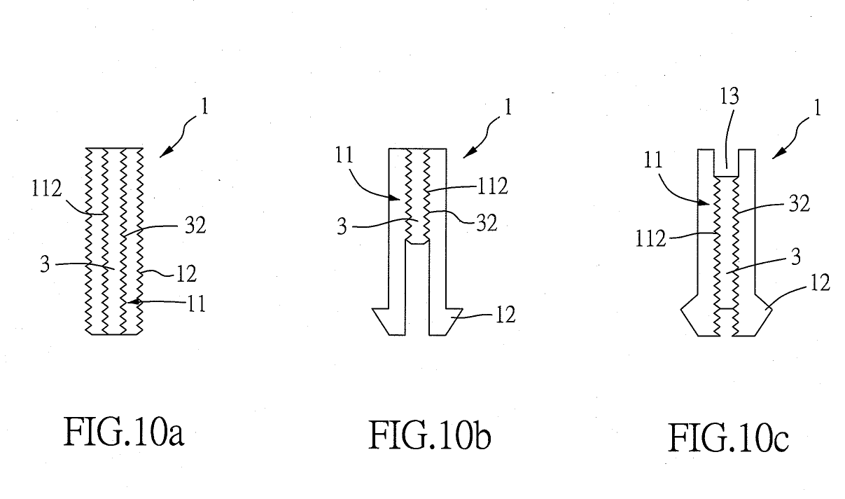

FIG. 10a through FIG. 10c are schematic views of the light-permeable body fastened to the receiving channel according to the first specific embodiment of the present invention. As shown in the diagrams, in the first specific embodiment, the light-permeable body 3 of the light-permeable fixing component has an external thread 32, and the receiving channel 11 has an internal thread 112, such that the external thread 32 and the internal thread 112 mesh with each other, thereby allowing the light-permeable body 3 to be conveniently positioned inside the receiving channel 11 and firmly fixed to the receiving channel 11 from within.

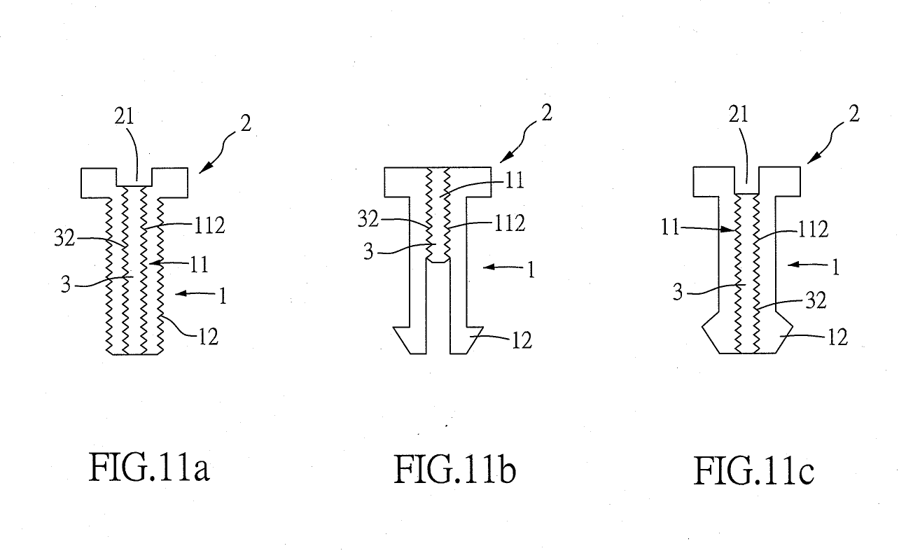

FIG. 11a through FIG. 11c are schematic views of the light-permeable body fastened to the receiving channel according to the second specific embodiment of the present invention. As shown in the diagrams, in the second specific embodiment, the light-permeable body 3 of the light-permeable fixing component has the external thread 32, and the receiving channel 11 has the internal thread 112, such that the external thread 32 and the internal thread 112 mesh with each other, thereby allowing the light-permeable body 3 to be conveniently positioned inside the receiving channel 11 and firmly fixed to the receiving channel 11 from within.

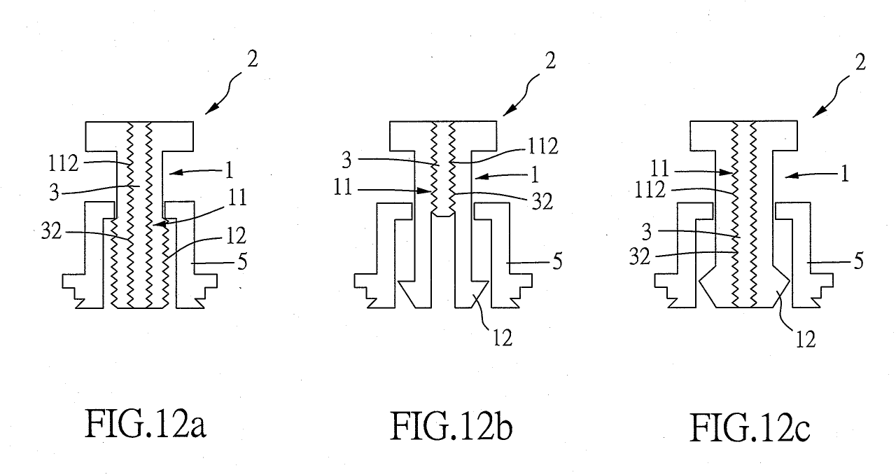

FIG. 12a through FIG. 12c are schematic views of the light-permeable body fastened to the receiving channel according to the third specific embodiment of the present invention. As shown in the diagrams, in the third specific embodiment, the light-permeable body 3 of the light-permeable fixing component has the external thread 32, and the receiving channel 11 has the internal thread 112, such that the external thread 32 and the internal thread 112 mesh with each other, thereby allowing the light-permeable body 3 to be conveniently positioned inside the receiving channel 11 and firmly fixed to the receiving channel 11 from within.

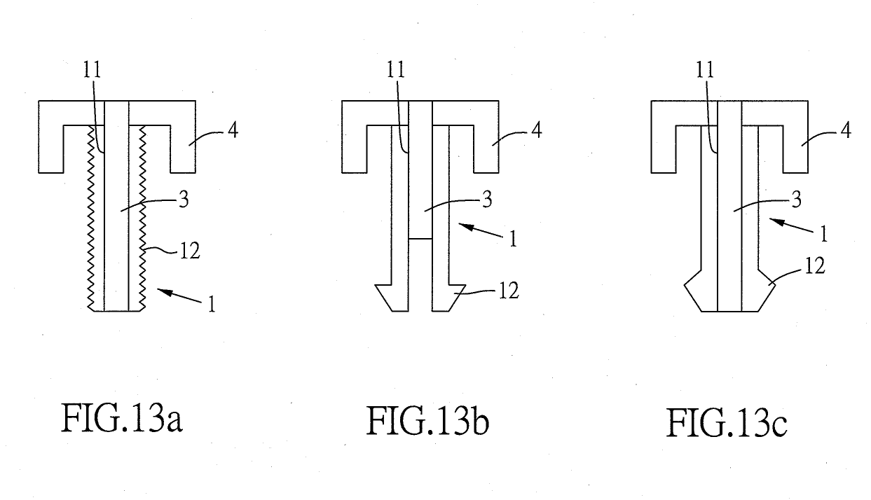

FIG. 13a through FIG. 13c are schematic views of the fixed body 1 to which a cap 4 is connected according to the first specific embodiment of the present invention. As shown in the diagrams, the light-permeable fixing component in the first specific embodiment further comprises a cap 4, and the fixed body 1 is connected to the cap 4 integrally to form a unitary structure, wherein the receiving channel 11 penetrates the cap 4. The purpose of the cap 4 is to connect to, cover or protect another object. Furthermore, the user can also use the cap 4 to control the fixed body 1.

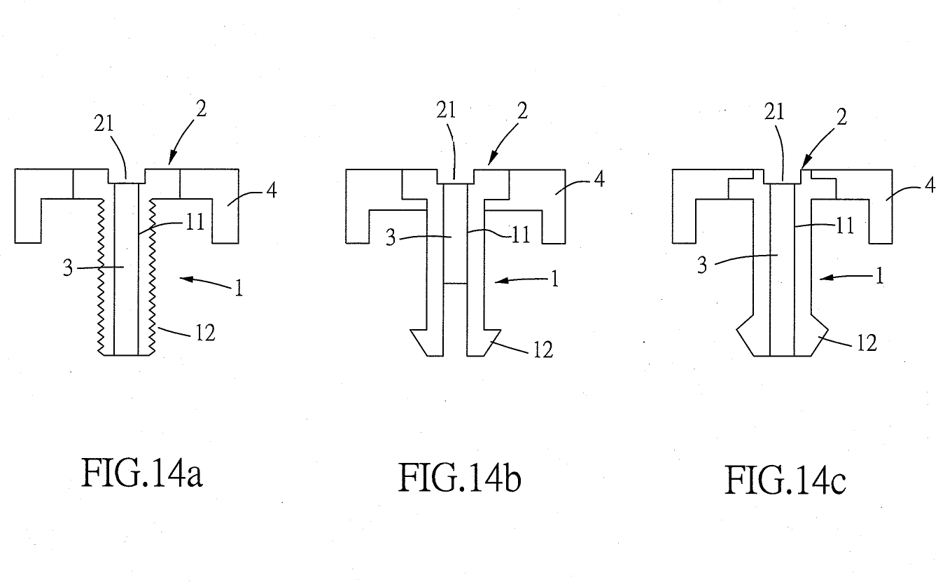

FIG. 14a through FIG. 14c are schematic views of the light-permeable fixing component with the cap 4 according to the second specific embodiment of the present invention. As shown in the diagrams, the light-permeable fixing component in the second specific embodiment further comprises the cap 4, and the fixed head portion 2 is connected to the cap 4 integrally to form a unitary structure, wherein the receiving channel 11 penetrates the cap 4. The purpose of the cap 4 is to connect to, cover or protect another object. Furthermore, the user can also use the cap 4 to control the fixed body 1.

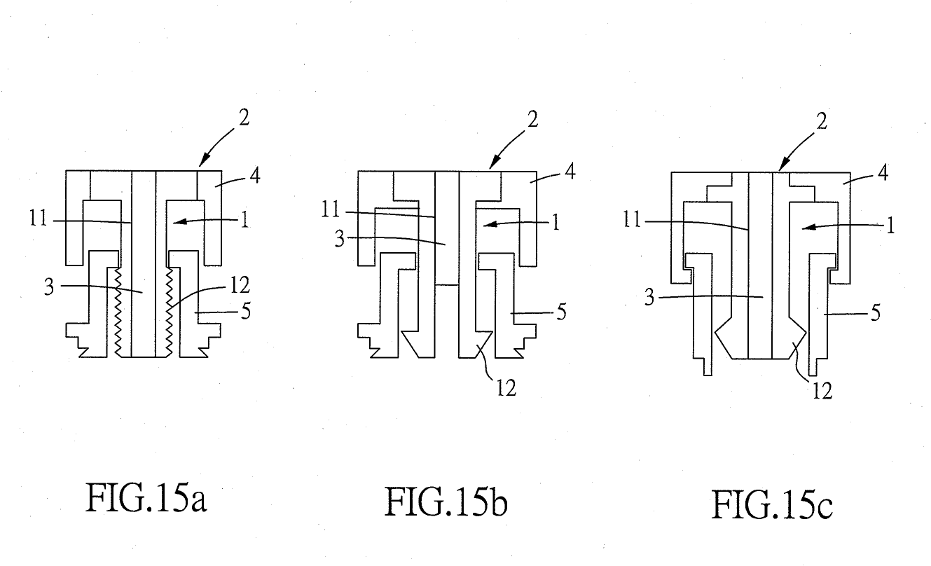

FIG. 15a through FIG. 15c are schematic views of the light-permeable fixing component with the cap 4 according to the third specific embodiment of the present invention. As shown in the diagrams, the light-permeable fixing component in the third specific embodiment further comprises the cap 4, and the fixed head portion 2 is connected to the cap 4 integrally to form a unitary structure, wherein the receiving channel 11 penetrates the cap 4, and the sleeve 5 is movably connected to the fixed body 1 or the cap 4. The purpose of the cap 4 is to connect to, cover or protect another object. Furthermore, the user can also use the cap 4 to control the fixed body 1.

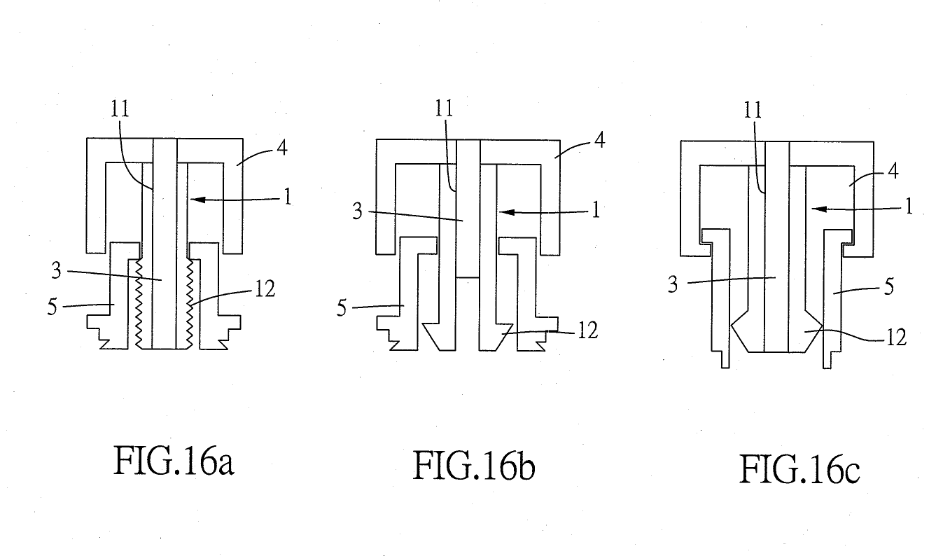

FIG. 16a through FIG. 16c are schematic views of the light-permeable fixing component with the cap 4 and the sleeve 5 according to the first specific embodiment of the present invention. As shown in the diagrams, the light-permeable fixing component shown in FIG. 13 and illustrated with the first specific embodiment further comprises the sleeve 5 which is movably connected to the fixed body 1 or the cap 4. As soon as the sleeve 5 is movably connected to the cap 4, the lower rim of the cap 4 protrudes inward, whereas the upper rim of the sleeve 5 protrudes outward. Afterward, the upper rim of the sleeve 5 abuts movably against the lower rim of the cap 4. The purpose of the sleeve 5 is as follows: the light-permeable fixing component of the present invention is positioned on an object by means of the sleeve 5, and then the fixed body 1 fixes another object in place.

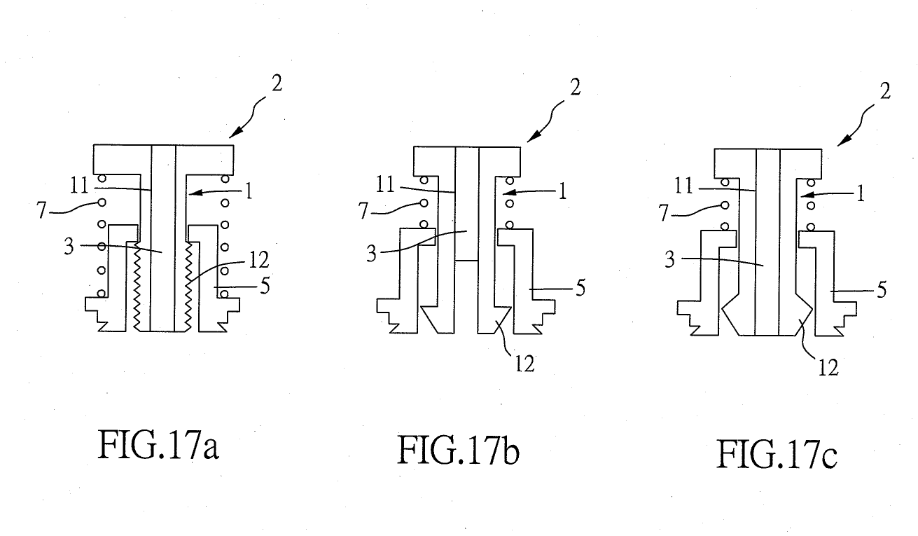

FIG. 17a through FIG. 17c are schematic views of the light-permeable fixing component with a resilient component 7 according to the third specific embodiment of the present invention. As shown in the diagrams, in the third specific embodiment, the light-permeable fixing component further comprises the resilient component 7 with one end abutting against the fixed head portion 2 and the other end abutting against the sleeve 5, such that the resilient component 7 lends support to the fixed body 1 whenever the light-permeable fixing component of the present invention is not in use.

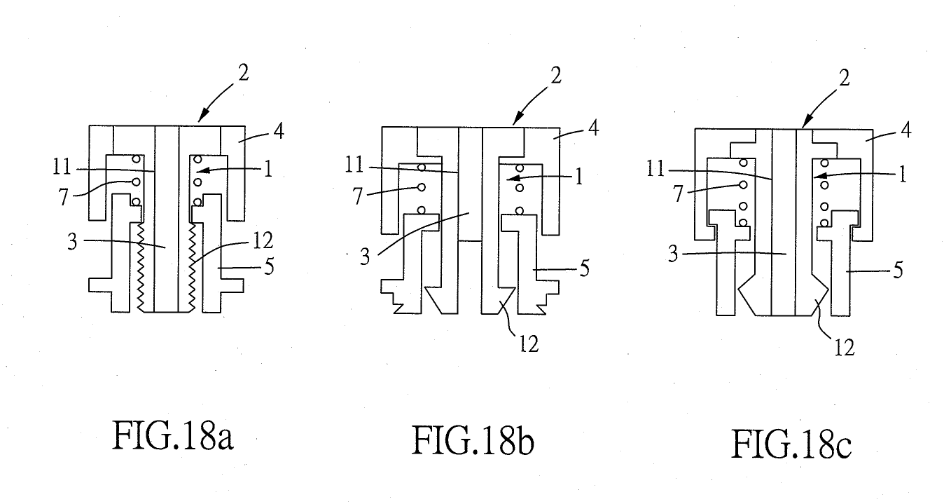

FIG. 18a through FIG. 18c are schematic views of the light-permeable fixing component with the cap 4 and the resilient component 7 according to the third specific embodiment of the present invention. As shown in the diagrams, in the third specific embodiment illustrated with FIG. 15, the light-permeable fixing component further comprises the resilient component 7 with one end abutting against the fixed head portion 2 or the cap 4 and the other end abutting against the sleeve 5, such that the resilient component 7 lends support to the fixed body 1 whenever the light-permeable fixing component of the present invention is not in use.

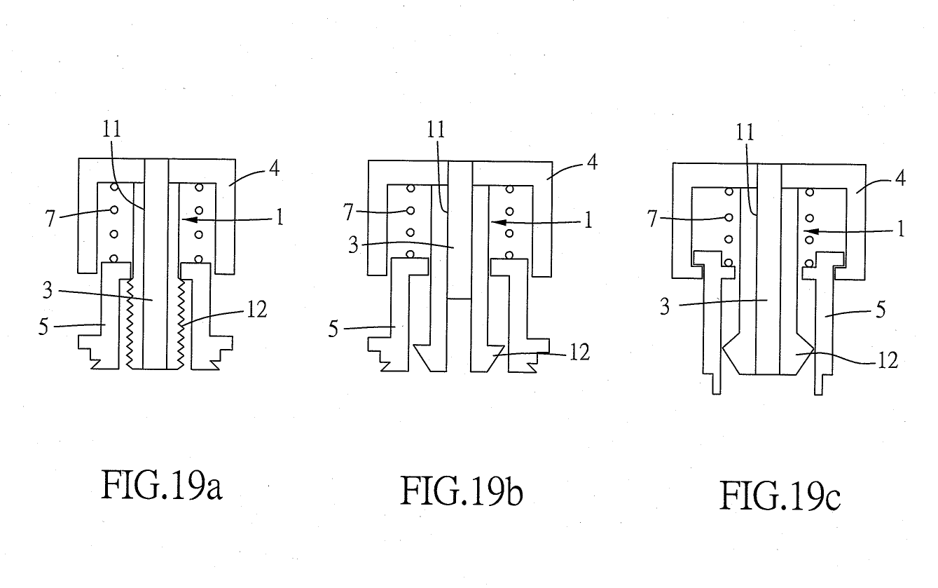

FIG. 19a through FIG. 19c are schematic views of the light-permeable fixing component with the cap, the sleeve, and the resilient component according to the first specific embodiment of the present invention. As shown in the diagrams, in the first specific embodiment illustrated with FIG. 16, the light-permeable fixing component further comprises the resilient component 7 with one end abutting against the cap 4 and the other end abutting against the sleeve 5, such that the resilient component 7 lends support to the fixed body 1 whenever the light-permeable fixing component of the present invention is not in use.

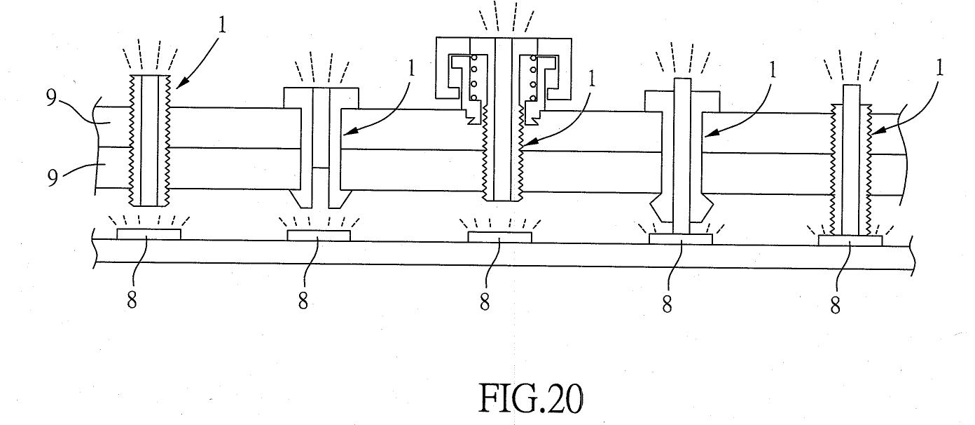

FIG. 20 is a schematic view of the use of the light-permeable fixing component according to a specific embodiment of the present invention. As shown in the diagram, after two objects 9, 9 have been fixed in place with the light-permeable fixing component, light generated from a light source 8 is guided from the lower end of the light-permeable fixing component to the upper end thereof before the light is emitted. The light source 8 is an LED, an incandescent light bulb, or a fluorescent lamp. Furthermore, after coming into contact with the lower end of the light-permeable fixing component of the present invention, the first rightmost one of the light sources 8 shown in FIG. 20 emits light. Also, after coming into contact with the light-permeable body 3 protruding from the lower end of the light-permeable fixing component of the present invention, the second rightmost one of the light sources 8 shown in FIG. 20 emits light.

The fixed body 1 of the light-permeable fixing component is made of a metal to thereby enhance the mechanical strength of the fixed body 1. Furthermore, to enable the light-permeable body 3 of the light-permeable fixing component to be light permeable, the light-permeable body 3 is made from optical fiber, fibrous material, plastic, glass, quartz, acrylic, rubber, or silicone.

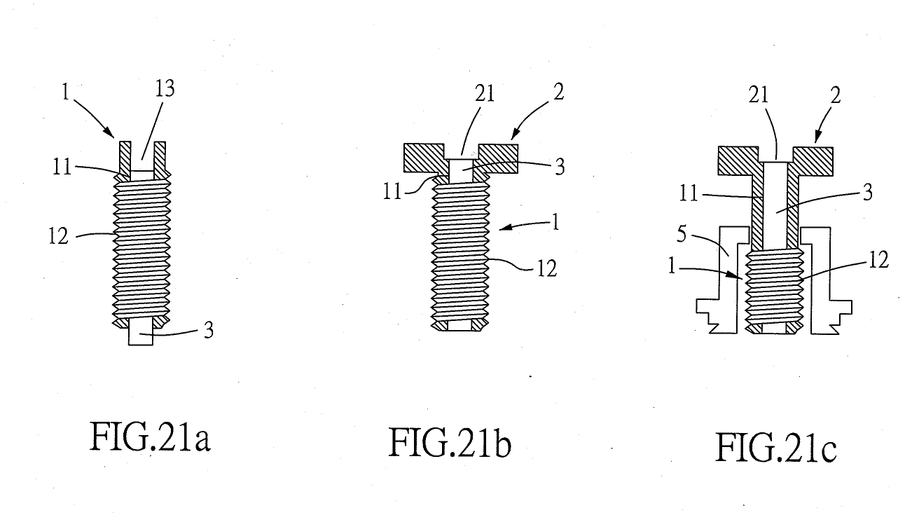

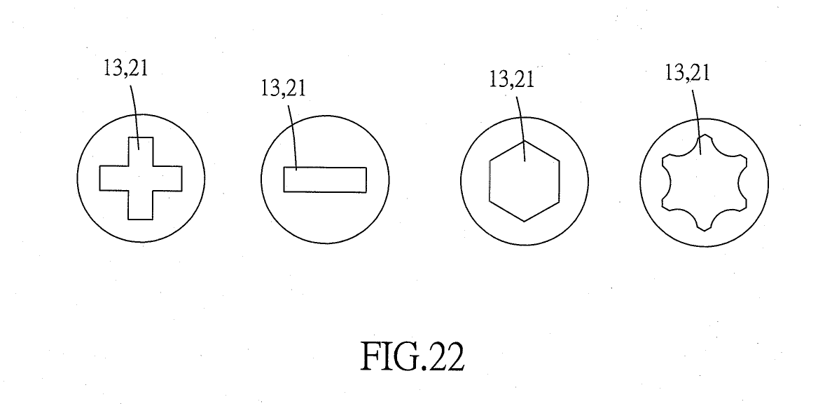

FIG. 21a and FIG. 22 are schematic views of an operation portion according to a specific embodiment of the present invention. As shown in the diagrams, in the first specific embodiment, a first operation portion 13 is disposed at the upper end of the fixed body 1 of the light-permeable fixing component, wherein, when viewed from the top of the light-permeable fixing component of the present invention, the recess of the first operation portion 13 is linear, cross-shaped, hexagonal, or five petal shaped, such that the user can use a tool of a corresponding shape to operate the light-permeable fixing component of the present invention.

FIG. 21b, FIG. 21c and FIG. 22 are schematic views of the operation portion according to a specific embodiment of the present invention. As shown in the diagrams, in the second specific embodiment and the third specific embodiment, a second operation portion 21 is disposed at the upper end of the fixed head portion 2 of the light-permeable fixing component, wherein, when viewed from the top of the light-permeable fixing component of the present invention, the recess of the second operation portion 21 is linear, cross-shaped, hexagonal, or five petal shaped, such that the user can use a tool of a corresponding shape to operate the light-permeable fixing component of the present invention.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A light-permeable fixing component, comprising:
a fixed body having a fixing portion, the fixing portion being disposed at the fixed body and being one of a thread, hook engagement bodies and snap-engagement bodies;
a receiving channel penetrating the fixed body; and
a light-permeable body disposed inside the receiving channel.

2. A light-permeable fixing component, comprising:
a fixed head portion;
a fixed body connected to the fixed head portion and having a fixing portion, the fixing portion being disposed at the fixed body and being one of a thread, hook engagement bodies and snap-engagement bodies;
a receiving channel penetrating the fixed head portion and the fixed body; and
a light-permeable body disposed inside the receiving channel.

3. A light-permeable fixing component, comprising:
a fixed head portion;
a fixed body connected to the fixed head portion and having a fixing portion, the fixing portion being disposed at the fixed body and being one of a thread, hook engagement bodies and snap-engagement bodies;
a receiving channel penetrating the fixed head portion and the fixed body;
a light-permeable body disposed inside the receiving channel; and
a sleeve movably connected to the fixed body.

4. The light-permeable fixing component of claim 1, wherein the light-permeable body protrudes from the fixed body.

5. The light-permeable fixing component of claim 2, wherein the light-permeable body protrudes from the fixed head portion and/or the fixed body.

6. The light-permeable fixing component of claim 1, wherein the light-permeable body is disposed inside the receiving channel by one of adhesion, insert injection, press-in, engagement, snap-engagement, and thermal fusion.

7. The light-permeable fixing component of claim 2, wherein the light-permeable body is disposed inside the receiving channel by one of adhesion, insert injection, press-in, engagement, snap-engagement, and thermal fusion.

8. The light-permeable fixing component of claim 3, wherein the light-permeable body is disposed inside the receiving channel by one of adhesion, insert injection, press-in, engagement, snap-engagement, and thermal fusion.

9. The light-permeable fixing component of claim 1, wherein the receiving channel has at least a first coupling portion, or the light-permeable body has at least a second coupling portion, wherein the first coupling portion and the second coupling portion are a protrusion or a recess.

10. The light-permeable fixing component of claim 2, wherein the receiving channel has at least a first coupling portion, or the light-permeable body has at least a second coupling portion, wherein the first coupling portion and the second coupling portion are a protrusion or a recess.

11. The light-permeable fixing component of claim 3, wherein the receiving channel has at least a first coupling portion, or the light-permeable body has at least a second coupling portion, wherein the first coupling portion and the second coupling portion are a protrusion or a recess.

12. The light-permeable fixing component of claim 1, wherein the light-permeable body has an external thread, and the receiving channel has an internal thread, such that the external thread and the internal thread mesh with each other.

13. The light-permeable fixing component of claim 2, wherein the light-permeable body has an external thread, and the receiving channel has an internal thread, such that the external thread and the internal thread mesh with each other.

14. The light-permeable fixing component of claim 2, further comprising a cap connected to the fixed head portion and penetrated by the receiving channel.

15. The light-permeable fixing component of claim 3, further comprising a cap connected to the fixed head portion and penetrated by the receiving channel, wherein the sleeve is movably connected to one of the fixed body and the cap.

16. The light-permeable fixing component of claim 3, further comprising a resilient component with one end abutting against the fixed head portion and the other end abutting against the sleeve.

17. The light-permeable fixing component of claim 1, wherein the fixed body is made of a metal.

18. The light-permeable fixing component of claim 2, wherein the fixed body is made of a metal.

19. The light-permeable fixing component of claim 3, wherein the fixed body is made of a metal.

20. The light-permeable fixing component of claim 1, wherein the light-permeable body is made from optical fiber, fibrous material, plastic, glass, quartz, acrylic, rubber, and silicone.

21. The light-permeable fixing component of claim 2, wherein the light-permeable body is made from optical fiber, fibrous material, plastic, glass, quartz, acrylic, rubber, and silicone.

22. The light-permeable fixing component of claim 3, wherein the light-permeable body is made from optical fiber, fibrous material, plastic, glass, quartz, acrylic, rubber, and silicone.

23. The light-permeable fixing component of claim 1, wherein the fixed body has a first operation portion.

24. The light-permeable fixing component of claim 2, wherein the fixed head portion has a second operation portion.
